(19) United States
(12) Patent Application Publication
(10) Pub. No.: US 2015/0052864 A1
(43) Pub. Date: Feb. 26, 2015

(54) Prefilter Wrap

(71) Applicant: American Air Filter Company, Inc., Louisville, KY (US)

(72) Inventor: Paul Jackson, North Shields (GB)

(21) Appl. No.: 14/465,939

(22) Filed: Aug. 22, 2014

Related U.S. Application Data
(60) Provisional application No. 61/869,357, filed on Aug. 23, 2013.

(51) Int. Cl. B01D 46/00

(52) U.S. Cl. CPC B01D 46/0024; B01D 46/0005
USPC 55/486

(57) ABSTRACT

A removable prefilter wrap having multiple layers is disclosed. The prefilter wrap may be configured to be placed around the outer circumference of a filter canister. The prefilter wrap has multiple layers for filtering water, oil(s), and/or other contaminants from an airflow.

### CROSS-REFERENCE TO PRIOR APPLICATION

This nonprovisional application claims priority to and benefit under 35 U.S.C. 119(e) to currently pending U.S. Provisional Application No. 61/869,357, filed Aug. 23, 2013, which is incorporated by reference in its entirety.

### TECHNICAL FIELD

Generally, a prefilter for a canister filter is taught. More specifically, present embodiments relate to a removable prefilter for use with a canister filter.

### BACKGROUND

Fine particles of salt, water, oil, and other chemical contaminants can be detrimental to canister filters. This contamination, in addition to standard dust and/or other particle loading, reduces life expectancy of canister filters. With higher efficiency filter canisters, loading can further reduce life expectancy and consequently increase operating costs. HEPA level filtration materials in canisters are among the most efficient materials available for canister filters and therefore typically display the shortest life expectancy due to loading and/or contamination.

Gas turbine filtration applications often utilize a filtration membrane layer, such as expanded polytetrafluoroethylene (ePTFE) or high molecular weight polyethylene (HMWPE), for high efficiency filter applications. An increase in the use of membrane filtration has come, at least in part, as a result of an increase in requests for filtration products capable of EPA and/or HEPA grade filtration efficiency. However, HEPA grade filtration may be difficult to achieve in some applications, such as those using marine gas turbines. This difficulty is at least partially due to the operating conditions that these filters are subjected to such as the amount and types of contaminants, as well as a requirement of minimal downtime. Further, industrial environments tend to reduce service life of gas turbine filters. This is generally due, at least in part, to face loading of membrane filtration materials caused by particulate, hydrocarbons, and moisture capture.

These issues have at times been combated in one of two ways. The first is to add a layer of prefiltration directly to the substrate. The second has been to utilize a filter wrap that can help pre-load and extend the life of the HEPA canister filter. These products typically focus only on particulate filtration. However, there are additional contaminants, which can reduce the service life of a filter, that existing prefilters do not address.

Thus, there is a need in the art for overcoming the issues of existing systems.

### SUMMARY

The present disclosure is directed towards prefilter apparatus for prefiltering a fluid flow. The prefilter is, in various embodiments, a multi-layer media that may be wrapped around an annular or canister filter. The prefilter also has hydrophobic, hydrophilic, oleophobic, and/or oleophilic properties.

Generally, in one aspect, a prefilter wrap for an annular filter is provided including a multilayer media adapted to encircle the annular filter. The multilayer media is removable from the annular filter. The multilayer media has at least two layers and allows at least a predetermined air flow as that of the annular filter. The first filtration layer forms the outer circumference of the wrap, which is also an in-flow surface. The first filtration layer includes an active material that is at least one of a hydrophobic, oleophobic, or oleophilic material, or combinations thereof. The particle retention second layer is a non-woven fibrous media and is encircled by the first filtration layer and interposed between the first filtration layer and the third support layer. The second layer may be formed of a high loft polyethylene. Optionally, one of the layers of the prefilter wrap may be formed of nonwoven polyolefin fibers and either of both of the first and second layers may include a density gradient of increasing density in a direction from the in-flow surface toward the annular filter. The wrap may include a first end and a second end each having a mating portion of a fastener adapted to detachably secure the ends together to form the wrap to removably wrap the prefilter wrap around the canister filter. The fastener may be a hook and loop fastener, mechanical snaps, or a strap. A fastener strap may be positioned around the outer circumference of the multilayer media or more specifically the first filtration layer. Alternatively, the wrap may be a radially elastically deformable sleeve that is removably attachable to the canister filter.

Generally, in another aspect, a prefilter wrap for a canister filter is provided including a permeable multilayer media. The media is wrapped around the circumference of the canister, which is hollow, so as to be removable from the canister filter. The media has a filtration first layer, a particulate retention second layer, and a third support layer. The first filtration layer forms the outer circumference and the in-flow surface of the media, and includes an active material that is hydrophobic, hydrophilic, oleophobic, and/or oleophilic. The second layer is formed of a non-woven fibrous media, it is encircled by the first layer, and interposed between the first and third layers. The third support layer is formed of non-woven polyolefin fibers. Optionally, the second layer may be formed of high loft polyethylene. Any or all of the first, second, and third layers may have a density gradient with increasing density in a direction from the in-flow surface toward the canister filter. The wrap may include a first end and a second end each having a mating portion of a fastener to detachably secure the ends together. The fastener may be a hook and loop fastener, mechanical snaps, or a strap. Alternatively, the wrap may be an elastically deformable sleeve that is removably attachable to the canister filter.

Generally, in another aspect, a prefilter wrap for a cartridge filter is provided including a multilayer media that is wrapped circumferentially around the cartridge filter, which is hollow, and is removable from the cartridge filter. The media has a first filtration layer, a particulate retention second layer, and a third support layer. The media is either elastically deformable in a radial direction, has a first end and a second end that are unattached to each other except for a detachable fastener that allows attachment and removal of the media from the filter, or both. The first layer forms an outer circumference and an in-flow surface of the media, and includes an active material that is hydrophobic, hydrophilic, oleophobic, and/or oleophilic. The second layer is formed of high loft polyethylene and is encircled by the first layer and interposed between the first and third layers. The third layer is formed of non-woven polyolefin fibers and is hydrophobic, hydrophilic, oleophobic and/or oleophilic. Optionally, the active material of the first layer is hydrophobic and that of the third layer is oleophobic. The fastener may be a hook and loop fastener or mechanical snaps.

### BRIEF DESCRIPTION OF THE DRAWINGS

FIG. 1 is a perspective view of an embodiment of a HEPA canister filter and a prefilter wrap;

FIG. 2 is an exploded perspective view of the HEPA canister filter and the prefilter wrap of FIG. 1;

FIG. 3 is a side view of a portion of an embodiment of a prefilter wrap; and

FIG. 4 is an exploded perspective view of an embodiment of layers forming a prefilter wrap.

### DETAILED DESCRIPTION

It is to be understood that the embodiments are not limited in their application to the details of construction and the arrangement of components set forth in the following description or illustrated in the drawings. Other embodiments are possible and may be practiced or carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “attached,” “connected,” or “coupled” and variations thereof herein are used broadly and encompass direct and indirect attachments, connections, and couplings. In addition, the terms “attached,” “connected,” or “coupled,” and variations thereof are not restricted to physical or mechanical attachments, connections, or couplings.

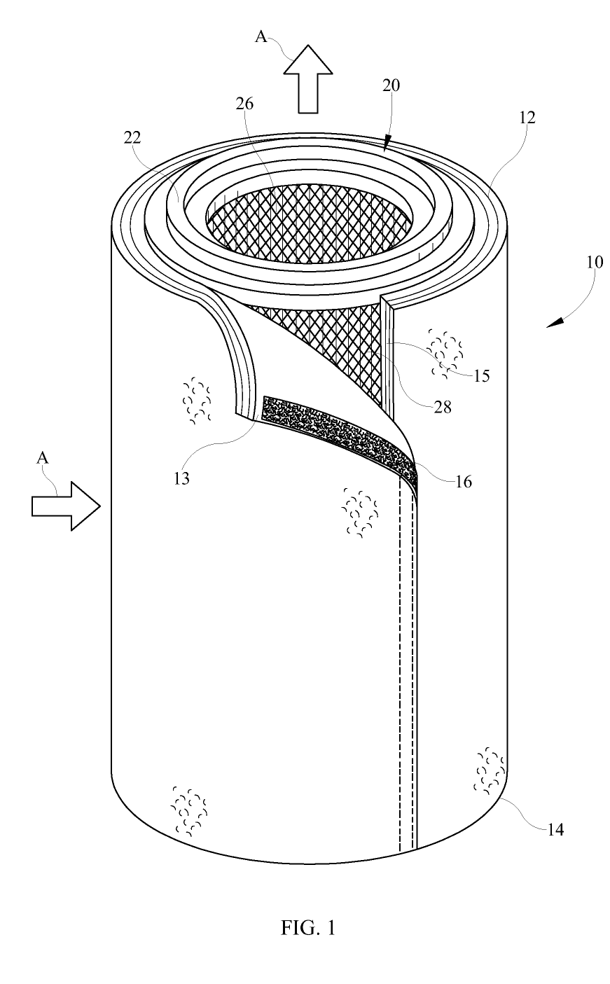

Referring now in detail to the drawings, wherein like numerals indicate like elements throughout several views, there are shown in FIGS. 1 through 4 various aspects of an exemplary prefilter wrap 10 for a filter canister or cartridge 20, such as, for example, a HEPA grade filter canister 20. The prefilter wrap 10 may be disposed over or around the filter canister 20 to prefilter a fluid flow, such as air flow A, before it reaches filter canister 20 in order to inhibit contamination of the filter canister 20 with particulates, oil, water, salt, and/or chemicals that may unnecessarily decrease the life of the filter canister 20. It may be beneficial to avoid decreases in the life of filter canister 20 (or other filter) as it may, in some embodiments, be high efficiency and/or relatively expensive relative to prefilter wrap 10.

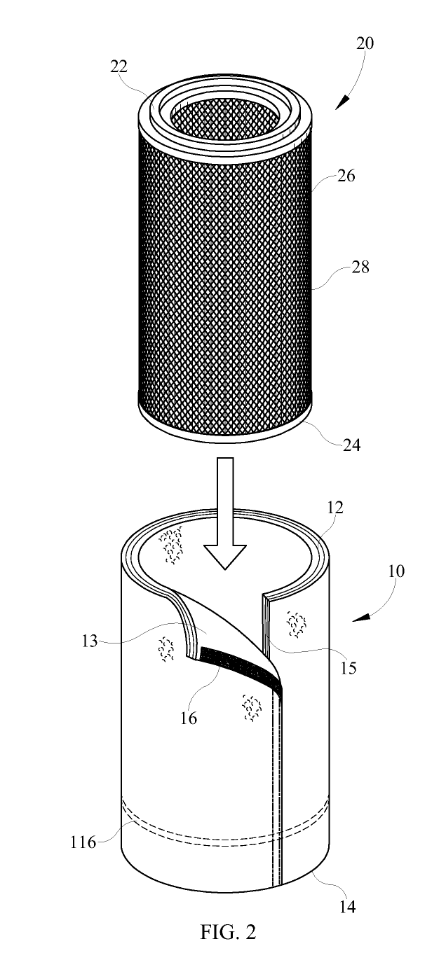

Referring now to FIG. 1, an embodiment of filter canister 20 with prefilter wrap 10 is shown. The prefilter wrap 10 extends about filter canister 20, which is cylindrical in this embodiment, to cover the outer surface of the filter canister 20. It is understood that filter canister 20 and/or prefilter wrap 10 may be substantially cylindrical, as shown, or may be any of a variety of other shapes, including, but not limited to tubular, polygonal, ovular, round, spherical, or any other shape, or any combination thereof. As shown, prefilter wrap 10 is partially detached from itself near a first, or upper, edge 12 to show a portion of the filter canister 20 therein and to indicate removability. The filter canister 20 may include a first end or end cap 22 and a second end or end cap 24 (see FIG. 2), and may also include a hollow central area defining an air pathway. Extending between the first end 22 and the second end 24 is a primary 125 filter 26. In some embodiments, primary filter 26 may be pleated and/or may include a filtration membrane layer, such as, for example, porous expanded polytetrafluoroethylene (ePTFE) and/or high molecular weight polyethylene (HMWPE), which may be used, for example, for HEPA grade filtration. A support structure 28 may extend between the first end 22 and the second end 24 to cover an inner and/or an outer surface of primary filter 26. It is understood that support structure 28, if included, may be disposed across either an outer surface or an inner surface of primary filter 26, or it may be internal to primary filter 26, or any combination thereof. It is further understood that support structure 28 may be a substantially mesh or screen structure, as shown, or it may be any of a variety of substantially open supporting structures. The support structure 28 may aid in supporting the shape of prefilter wrap 10 and/or in prevention of filter collapse under service pressures. For example, air in air flow A may be filtered by prefilter wrap 10, then filtered by primary filter 26, and filtered air of air flow A may move out through the hollow passageway of the filter canister 20.

Prefilter wrap 10 may be disposed around an outer perimeter or surface, such as an air in-flow surface, of the filter canister 20. The prefilter wrap 10 may include upper edge 12 and/or a second, or lower, edge 14, as well as a first end 13 and a second end 15. However, other shapes may be utilized for the prefilter wrap 10, which may correspond to the shape of the filter canister 20 (such as the shapes mentioned above for the filter canister 20, for example). It is understood, however, that the shape of the prefilter wrap 10 may be independent of the shape of the filter canister 20. For example, although the prefilter wrap is shown as having an open end at the lower and upper edges 14, 12, it is to be understood that the wrap may have a bottom or top wall at one or more ends of the elongated cylindrical wrap creating a fully or partially closed end. This bottom or top wall may be of the same one or more layers of the cylindrical sidewall between the opposing ends or dissimilar in the number of layers and/or materials. The prefilter wrap 10 may extend around an outside perimeter or circumference of the filter canister 20. First end 13 and second end 15 may be held together by a fastener 16. The fastener 16 may be substantially a hook and loop type fastener that extends in an axial direction, as shown. The fastener 16 may be comprised of buttons, snaps, latches, and/or other fastening structures. Fastener 16 may have a first mating portion near first end 13 of prefilter wrap 10 and a second mating portion near second end 15 of prefilter wrap 10, either or both of which may be adapted to be fastened, attached, and/or connected together to detachably secure the prefilter wrap 10 in its wrapped form. In some embodiments the prefilter wrap 10 may be in the form of a sleeve that may have a seamed or stitched joint forming a fixed sleeve or tube, which may slide axially over the canister 20 at either end cap 22, 24, for example, for installation and/or removal from filter canister 20. The sleeve may be elastically deformable, for example, in a radial direction or radially to vary the circumference, to facilitate removability (and/or installation) of prefilter wrap 10 from (or on) filter canister 20.

Referring to FIG. 2, in some embodiments there may be included one or more fastener straps 116 extending around at least a portion of prefilter wrap 10. The fastener strap 116 may be a band, strap, or other structure that extends about the prefilter wrap 10. The fastener strap 116 may have a hook and loop fastener, and/or any of a variety of other fasteners, which may removably retain the prefilter wrap 10 around the filter canister 20. Fastener strap 116 may be include any of a variety of materials including, but not limited to, hook and loop fasteners or adhesively attached materials, or any other material, which may aid in securing fastener strap 116 around at least a portion of prefilter wrap 10. Fastener strap 116 may be used instead of or in addition to fastener 16. Using any of these features or other features, alone or in combination, may facilitate removal of prefilter wrap 10 so that it may, for example, be replaced, or cleaned and reused, to increase the life of filter canister 20.

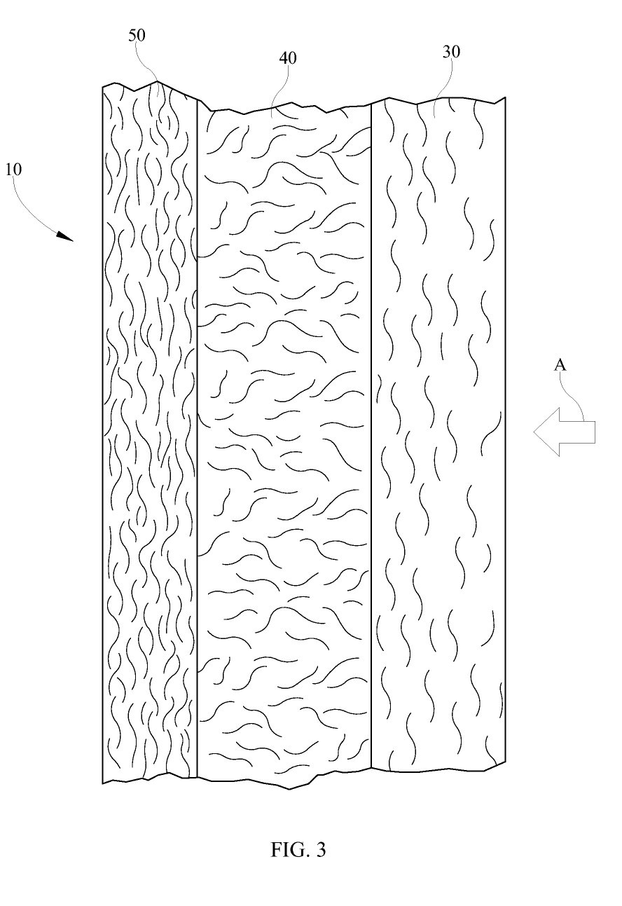

In FIG. 2 the prefilter wrap 10 is shown exploded from the filter canister 20. The prefilter wrap 10 may be formed of multiple layers, such as, for example, layers 30, 40, 50 (see FIG. 3). The multiple layers 30, 40, 50 may be stacked or attached to form the multilayer media. Any of a variety of materials may be used to form any or all of layers 30, 40, 50, including, but not limited to, non-woven polyester, polypropylene, polyethylene, and/or any of a variety of polyolefins or other materials, or any combination thereof. The layers 30, 40, 50 may be attached in any of a variety of ways, including, but not limited to: being stitched together, for example, at or near one or more ends and/or edges; being laminated, glued, and/or adhered together; any two adjacent layers being at least partially intertangled; and/or any of a variety of methods of attachment, or a combination thereof. Any or all of layers 30, 40, 50 may include or be treated with an active material, such as a fluorochemical (for example, fluorocarbon) which may act as a hydrophobic, hydrophilic, and/or otherwise water filtering material; and/or an oleophobic, oleophilic, and/or otherwise oil filtering material; or a repellant of any of a variety of other chemicals or materials; or any combination thereof. It is understood that any of a variety of chemicals or materials, including but not limited to fluorechemicals, may be used to provide and/or enhance the water and/or oil filtering characteristics of the prefilter wrap 10.

The multiple layers may act as a low pressure drop prefilter for the filter canister 20, which may be used, for example, with combustion engine air intake systems, or with any of a variety of systems or applications. The prefilter wrap 10 may significantly prolong the life of the filter canister 20 by, for example, capturing dust or other particulate contaminants such as fibers, pollen, seeds and other particulate matter, as well as filtering out water, oil, and/or other contaminants, that may be present in a plant, manufacturing facility, or any of a variety of environments. For example, in some applications it has been observed that the life of a filter canister (e.g., filter canister 20) has been increased from approximately 6 months to approximately 2 years by using a prefilter wrap (e.g., prefilter wrap 10). Although in this example the life of the prefilter wrap 10 may be approximately 6 months as a result of reaching its loading capacity (instead of filter canister 20 reaching its loading capacity), the prefilter wrap 10 may be washable and/or reusable to increase its usable lifespan.

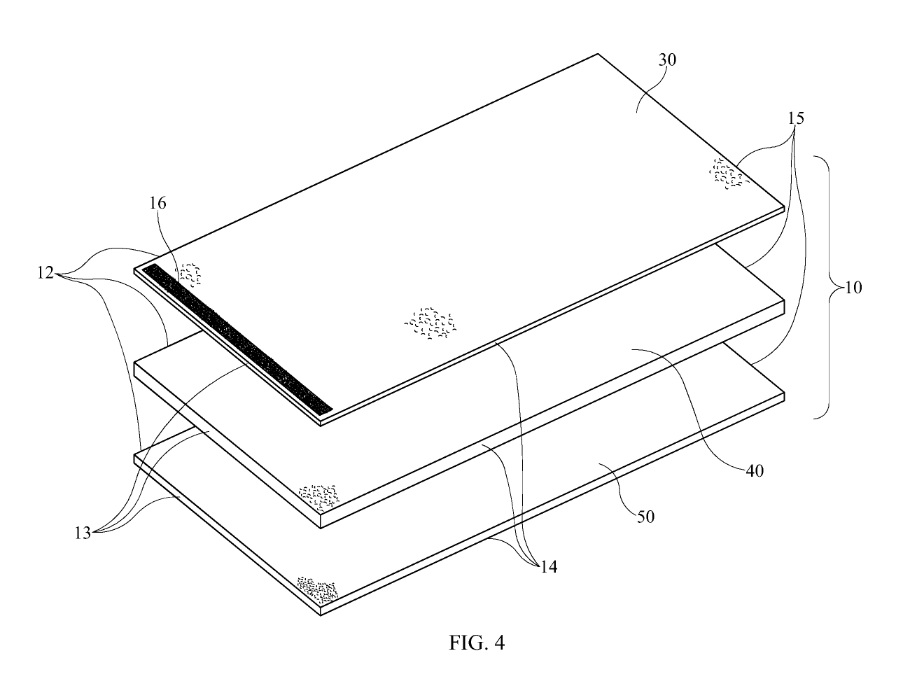

Referring to FIGS. 3 and 4, prefilter wrap 10 may have a first or first filtration layer 30, a second or particulate retention second layer 40, and/or a third or third support layer 50. Any or all of layers 30, 40, 50 and/or any additional layers may form the multilayer media of prefilter wrap 10. First layer 30 may, in some embodiments, absorb or repel water, and/or absorb or repel oil(s). For example, the material used for first layer 30 may be processed so that it will repel water away from the prefilter wrap 10, thus limiting the amount of water that may otherwise reach the filter canister 20. In some embodiments, the hydrophobic material may be included in the filter layer 30, for example, as the binder. A C6 chemistry fluoropolymer may be used, although it is understood that other materials may be used instead of or in addition to C6 fluoropolymer. In some embodiments, the first layer 30 may be hydrophilic and/or have a fluorochemical content of between about one and twenty percent. The first layer 30 may be, for example, a fluorochemical treated non-woven polyester. Any of a variety of weights of material may be used for first layer 30, but first layer 30 may have a weight of about 10 to 100 grams per square meter. In some embodiments, the weight of the material used to form first layer 30 may be about 30 grams per square meter. A specific type and/or brand of fluorochemical material that may be used includes, but is not limited to, those marketed as “Unidyne” by Daikin Industries, Ltd. For example, TG-580 or TG-581 may be utilized. It is understood that the first layer 30 may have any of a variety of characteristics to provide a desired functionality for specific contaminants, such as to repel or absorb water, oil, and/or any of a variety of chemicals. Each layer 30, 40, 50 may be formed with a specific characteristic or functionality, as desired. Each layer 30, 40, 50 of prefilter wrap 10 may be independently manufactured to include desired characteristics and/or have increased modularity. The layers 30, 40, 50 may subsequently be coupled or attached. Thus, for example, a modification to first layer 30 may not require retooling and/or resupplying for second layer 40 and/or third layer 50.

Second layer 40 may capture and/or retain particulate material. In some embodiments, second layer 40 may be formed of a high loft polyethylene layer. The second layer 40 may have a weight of about 10 to 100 grams per square meter. In some embodiments the second layer 40 may be a high loft polyethylene having greater than 30% air by volume. Second layer 40 may be modified to have certain characteristics depending on the environment in which the prefilter wrap 10 and/or filter canister 20 are to be utilized. Similarly, in some embodiments, prefilter wrap 10 may be modified to have certain characteristics, for example, by adding, replacing, or altering layers, or switching the upstream or downstream positioning of the layers relative to air flow A. It is understood that any of a variety of materials may be used to form second layer 40, including, but not limited to, polyethylene, high loft polyethylene, needle felt, non-woven organic fibers, non-woven synthetic fibers, and/or any other material, or a combination thereof.

Third layer 50 may be a support layer giving prefilter wrap 10 enhanced structural rigidity. In some embodiments, third layer 50 may be formed of various materials including, but not limited to, polyethylene (or other polyolefin) spun bond, polyethylene (or other polyolefin) air laid, bi-component spun bond, or bi-component air laid, any of a variety of mono-component materials, and/or any of a variety of other materials, which may provide some structural rigidity. Third layer 50 may have sufficient strength and heat setting characteristics to support second layer 40 and/or first layer 30. Third layer 50 may repel or absorb hydrocarbons such as, for example, oil. The third layer 50 therefore may act as an oleophobic or oleophilic material. The third layer 50 may be formed of polypropylene. It is understood that third layer 50 is not limited to a polypropylene construction, and that any of a variety of polyolefins or other materials may be used to form third layer 50. Third layer 50 may be treated or otherwise include materials that increase its oil and/or water filtering characteristics. A fluorochemical material may be included with third layer 50, for example, a specific type and/or brand of fluorochemical material that may be included is Unidyne fluorochemical TG-993. However, it is understood that this is merely one of a variety of examples and should not be considered limiting. The third layer 50 may have a weight of between about 10 and 100 grams per square meter and, in some embodiments, may have a weight of about 30 grams per square meter. The various layers may have any of a variety of characteristics and may be intended to filter specific contaminants, such as, for example, to repel or absorb a specific chemical and/or particulates within a predetermined size range. It is understood that the layers 30, 40, 50 and/or any additional layers may be connected or coupled to each other in fluid communication to allow air flow A therethrough. It is further understood that layers 30, 40, 50 and/or any additional layers may be arranged in any order, with any layer being the furthest upstream layer in air flow A, interposed between other layers, or the furthest downstream layer in air flow A.

The first, second, and/or third layers 30, 40, 50 may be formed of two or more fiber sizes that are in the range of about 0.9 to 200 denier. Each layer 30, 40, 50 may be formed of fiber sizes that may form a density gradient within each layer and/or through the prefilter wrap 10. Any of a variety of methods of measuring or determining density may be used, but in some embodiments the density may be measured in grams per square meter, for example, of the fibers that form the layer. In some embodiments, it may be desirable that the largest pore sizes and/or largest fiber sizes are located at or near the fluid entry side or air in-flow surface of the the respective layer 30, 40, 50, while the smallest fiber sizes and/or smallest pore sizes are located at or near the fluid exit side or surface of the respective layer 30, 40, 50. This gradient may cause gradual filtration as air moves in an airflow direction A through any or all of the first layer 30, second layer 40, and/or third layer 50. It is understood that, although gradient density may be included in the layers 30, 40, 50, gradient density is not required and any of a variety of a fiber densities may be used for any or all of the three layers 30, 40, 50 and/or any additional layers that may be included. It is further understood that in some embodiments the density of each layer may be determined independently of the density of any other layer. In some embodiments, the layers 30, 40, 50 may form substantially a seamless multilayer composite of fibers having a relatively smooth and/or continuous gradient density, if a gradient density is included.

The fiber combinations and process steps taken to produce the prefilter wrap 10 and/or any or all of layers 30, 40, 50 may be such that a self-supporting filter media having a Gurley stiffness of at least about 500 mg is provided. In some embodiments, third layer 50 may be the primary support layer and may be a predominant factor in determining the Gurley stiffness of the prefilter wrap 10, although it is understood that any other layer or other feature or combination thereof may predominantly determine the overall Gurley stiffness of prefilter wrap 10. A permeability of the prefilter wrap 10 may be in a range of about 100 to 700 cubic feet per minute over square feet (cfm/sq. ft.). Any gradient density may increase the level of filtration in the direction of airflow through the prefilter wrap 10 and/or any or all layers 30, 40, 50. For example, the largest particles may be filtered first from air flow A, with gradually smaller particles being filtered by prefilter wrap 10 as air flow A progresses therethrough. However, it is understood that the order of the coarse to fine fibers may be changed as desired for needed filtration. It is further understood that in some embodiments, any or all layers 30, 40, 50 may be porous and/or in the form of a membrane.

The individual layers 30, 40, 50 may be formed of bi-component fibers, or mono-component fibers, or both. If both bi-component and mono-component fibers are used, the bi-component material may be in the range of about 20% to 100% with the remainder substantially being mono-component fibers. The layers 30, 40, 50 may be compressed, connected, or coupled to form multi-layer melt or fuse bonded media that may have a gradient density. The bi-component fibers may have a high melting portion and a low melting portion. In some embodiments, the high melting portion may be polyester and the low melting portion may be polypropylene, co-polyester, and/or polyethylene. The layers 30, 40, 50 may have at least one of polyethylene, polyester, and polypropylene. Additionally, any or all of the layers may be treated with other materials, for example, activated carbon. Activated carbon may be used in some embodiments to aid in removal of gaseous contaminants and/or odors. In some applications activated carbon or similar features may even be required for removal of gaseous contaminants and/or odors. It is understood, however, that activated carbon is not required for all applications and it may be not present in some embodiments, or it may be substituted with a suitable replacement.

In some embodiments, it may be advantageous to maintain an equal share of the terminal differential pressure on each individual layer 30, 40, 50. Prefilter wrap 10 may have a rated air flow or air flow rating in a range of about 400-1200 cubic feet per minute (CFM), which may correspond with a rated air flow of a corresponding filter canister 20. In some embodiments, the prefilter wrap 10 may have a rated air flow of about 1000 CFM, which may correspond to the rated air flow of a corresponding filter canister 20. It is understood that any of a variety of rated air flows for prefilter wrap 10, filter canister 20, or both may be used. By having a rated airflow that corresponds with at least the rated air flow of corresponding filter canister 20, prefilter wrap 10 may allow at least about an amount of air flow through filter canister 20 without prefilter wrap 10 being the limiting factor on airflow. Thus, each layer 30, 40, 50 may be sufficiently open to allow the desired airflow therethrough and through prefilter wrap 10 overall. In some embodiments, the prefilter wrap 10 may have a pressure drop ranging from about 0.1 inch to about 1 inch at 750 CFM. When the pressure drop reaches the pre-selected level, the prefilter wrap 10 may be removed from the filter canister 20 and cleaned by, for example, washing or pulse air cleaning. Thus, the structure may be reusable and the fastener 16 and/or fastener strap 116 may enhance such reusability and/or washability by, for example, facilitating removal and/or attachment or installation of prefilter wrap 10 to or from filter canister 20.

Although prefilter wrap 10 is depicted in the figures as a substantially three layer composite having first layer 30, second layer 40, and third layer 50, it is understood that any combination of the layers 30, 40, 50 may be included, and/or may include additional layers, in virtually any combination. For example, only one of layers 30, 40, 50 may be included in prefilter wrap 10; or any two of the layers 30, 40, 50 may be included with or without a third layer, such as, for example, first layer 30 and second layer 40 without third layer 50, first layer 30 and third layer 50 without second layer 40, second layer 40 and third layer 50 without first layer 30, and/or any one layer 30, 40, 50 with an additional layer not depicted in the figures. It is understood that these are merely examples and do not limit the possible variations that may be used to form prefilter wrap 10.

While several embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms. The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases.

Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

The foregoing description of several methods and embodiments have been presented for purposes of illustration. It is not intended to be exhaustive or to limit the precise steps and/or forms disclosed, and obviously many modifications and variations are possible in light of the above teaching. It is intended that the scope and all equivalents be defined by the claims appended hereto.

What is claimed is:

1. A prefilter wrap for an annular filter comprising:
a multilayer media adapted to removably encircle an annular filter, said multilayer media having at least a filtration first layer and a particulate retention second layer, said annular filter having a predetermined air flow rating, said multilayer media having at least said predetermined air flow rating;
said first layer being a non-woven fibrous media having at least one of a hydrophobic material and an oleophobic material, said first layer forming an outer circumference of said multilayer media, said outer circumference being an in-flow surface; and
said second layer being a non-woven fibrous media encircled by said first layer, said second layer interposed between said first layer and said annular filter.

2. The prefilter wrap of claim 1 wherein said first layer is formed of nonwoven polyolefin fibers.

3. The prefilter wrap of claim 1 wherein at least one of said first and second layers has a density gradient of increasing density in a direction from said in-flow surface toward said annular filter.

4. The prefilter wrap of claim 1 further comprising a fastener having a first mating portion near a first end of said multilayer media and a second mating portion near a second end of said multilayer media, said first mating portion and said second mating portion adapted to detachably secure said first end to said second end to form said wrap.

5. The prefilter wrap of claim 4 wherein said fastener is a hook and loop fastener.

6. The prefilter wrap of claim 4 wherein said fastener further comprises mechanical snaps.

7. The prefilter wrap of claim 1 further comprising a fastener strap around said outer circumference of said multilayer media.

8. The prefilter wrap of claim 1 wherein said multilayer media is a sleeve that is radially elastically deformable so that said multilayer media is removably attachable to encircle said annular filter.

9. A prefilter wrap for a canister filter comprising:
a permeable multilayer media circumferentially removably wrapped around a canister filter, said canister filter being hollow, said multilayer media having a first filtration layer, a particulate retention second layer, and a third support layer;
said first filtration layer forming an outer circumference and an in-flow surface of said multilayer media, said first filtration layer including an active material that is at least one of hydrophobic, hydrophilic, oleophobic, and oleophilic;
said second layer formed of non-woven fibrous media, said second layer encircled by said first filtration layer and interposed between said first filtration layer and said third support layer; and
said third support layer formed of non-woven polyolefin fibers.

10. The prefilter wrap of claim 9 wherein said second layer is formed of high loft polyethylene.

11. The prefilter wrap of claim 9 wherein at least one of said first filtration, second, and third support layers has a density gradient with increasing density in a direction from said in-flow surface toward said canister filter.

12. The prefilter wrap of claim 9 further comprising a fastener having a first mating portion near a first end of said multilayer media and a second mating portion near a second end of said multilayer media, said first mating portion and said second mating portion adapted to detachably secure said first end to said second end to removably wrap the prefilter wrap around said canister filter.

13. The prefilter wrap of claim 12 wherein said fastener is a hook and loop fastener.

14. The prefilter wrap of claim 12 wherein said fastener further comprises mechanical snaps.

15. The prefilter wrap of claim 9 further comprising a fastener strap around said outer circumference of said first filtration layer.

16. The prefilter wrap of claim 9 wherein said multilayer media is a sleeve that is radially elastically deformable so that said multilayer media is removably attachable to encircle said canister filter.

17. A prefilter wrap for a cartridge filter comprising:
a multilayer media circumferentially removably wrapped around a cartridge filter, said cartridge filter being hollow, said multilayer media having a first filtration layer, a particulate retention second layer, and a third support layer;
said multilayer media at least one of:
a) is radially elastically deformable and
b) having a first end and a second end that are unattached except for a detachable fastener, to allow attachment and removal of said multilayer media from said cartridge filter;
said first filtration layer forming an outer circumference and an in-flow surface of said multilayer media, said first filtration layer including an active material that is at least one of hydrophobic, hydrophilic, oleophobic, and oleophilic;
said second layer formed of high loft polyethylene, said second layer encircled by said first filtration layer and interposed between said first filtration layer and said third support layer; and
said third support layer formed of non-woven polyolefin fibers, said third support layer is at least one of hydrophobic, hydrophilic, oleophobic, and oleophilic.

18. The prefilter wrap of claim 17 wherein said active material of said first layer is hydrophobic and said third support layer is oleophobic.

19. The prefilter wrap of claim 17 wherein said fastener is a hook and loop fastener.

20. The prefilter wrap of claim 17 wherein said fastener further comprises mechanical snaps.
